(19) United States
(12) Patent Application Publication
(10) Pub. No.: US 2014/0044850 A1
(43) Pub. Date: Feb. 13, 2014

(54) OVEN FOR COOKING MULTIPLE FOOD TYPES WITH DIFFERENT START AND STOP TIMES

(71) Applicant: William J. McMahon, Bloomington, MN (US)

(72) Inventor: William J. McMahon, Bloomington, MN (US)

(21) Appl. No.: 13/756,989

(22) Filed: Feb. 1, 2013

Related U.S. Application Data
(60) Provisional application No. 61/594,590, filed on Feb. 3, 2012.

(51) Int. Cl. A21B 1/24

(52) U.S. Cl. CPC A21B 1/245
USPC 426/523

(57) ABSTRACT

The present invention provides a process for cooking food items in an oven that allows single-temperature rapid cooking of multiple food items, including multiple food types, with the same or different cooking start times, wherein the food types may comprise different cooking periods from start to stop. A timer mechanism is provided for each individual cooking period, wherein each cooking period is set to optimize cooking of each different food type and/or a different cooking start time. One embodiment of the present invention allows up to four different cooking times to be established, with annunciation of completion of each cooking time, wherein the annunciator may comprise light and/or sound.

### RELATED APPLICATION

This applications claims priority to provisional application 61/594,590 entitled Multiple Use Oven, filed Feb. 3, 2012, the entire contents of which are hereby incorporated by reference.

### BACKGROUND OF THE INVENTION

1. Field of the Invention

The invention relates generally to an oven comprising a cooking chamber with multiple cooking tray levels and a timer mechanism comprising start and stop timers for at least each of the cooking tray levels within the cooking chamber. More specifically, the oven allows very fast cooking of multiple food items, of the same food type or of varying food type, each food item having different start and top times.

2. Description of the Related Art

Cooking ovens that combine heating technologies into a single cooking chamber are known in the art. For example, U.S. Pat. No. 5,676,044 to Lara, Jr., describes a closed loop oven comprising heating technologies consisting of the combination of radiant heat, convection and rotary air impingement. The patent to Lara is commonly assigned with the present application and is hereby incorporated herein in its entirety.

What the relevant art does not provide, however, is a cooking chamber that is capable of rapidly cooking multiple food items, i.e., more than one or more than two or more food items within the same cooking chamber, wherein each food item comprises a different stop and start time. Moreover, the art does not teach or suggest such a cooking chamber where a single temperature is used to rapidly cook a variety of different food types, e.g., a sandwich, bread dough and a pizza, each of which will be cooked at the same temperature and each of which will require different cooking times. Finally, the art does not teach or suggest such a cooking chamber wherein a single temperature is used to cook a variety of different food types, all cooked at the same temperature, but wherein the varying food types comprise different start times as well as different cooking times.

### BRIEF SUMMARY OF THE INVENTION

The present invention provides an oven that allows single-temperature rapid cooking of multiple food items, including multiple food types, with the same or different cooking start times, wherein the food types may comprise different cooking periods from start to stop. A timer mechanism is provided for each individual cooking period, wherein each cooking period is set to optimize cooking of each different food type and/or a different cooking start time. One embodiment of the present invention allows up to four different cooking times to be established, with annunciation of completion of each cooking time, wherein the annunciator may comprise light and/or sound.

The figures and the detailed description which follow more particularly exemplify these and other embodiments of the invention.

### BRIEF DESCRIPTION OF THE DRAWINGS

FIG. 1 is a flow chart of one embodiment of the present invention.

The invention may be more completely understood in consideration of the following detailed description of various embodiments of the invention in connection with the accompanying drawings, which are as follows.

### DETAILED DESCRIPTION OF THE INVENTION, INCLUDING THE BEST MODE

While the invention is amenable to various modifications and alternative forms, specifics thereof are shown by way of example in the drawings and described in detail herein. It should be understood, however, that the intention is not to limit the invention to the particular embodiments described. On the contrary, the intention is to cover all modifications, equivalents, and alternatives falling within the spirit and scope of the invention.

The oven of the present invention comprises, as described in U.S. Pat. No. 5,676,044 to Lara, a combination of heating technologies comprising radiant heat, convection and rotary air impingement. There is provided, as disclosed in Lara and incorporated herein by reference, a single cooking chamber.

The present invention improves the oven of Lara by extending its capabilities to include a cooking process incorporating multiple cooking periods for different foods which may or may not be of different types and which may or may not have different cooking periods. The oven itself is provided with a set temperature that is fixed by the operator. An exemplary set temperature may be 450 degrees Fahrenheit which is facilitated by the combination of heating technologies of infrared radiant heat, convection and rotary air impingement.

Once the set temperature is fixed, and reached within the cooking chamber as evidenced by a commonly known digital temperature monitor, the cooking process may begin.

As noted briefly above, the present invention allows a wide variety of food to be rapidly cooked over the course of a day in, e.g., a restaurant setting. Because of the combination of convection, direct infrared and rotary air impingement technologies, the cooking time that is normally recommended for, e.g., a freshly made pizza, is greatly shortened from, e.g., 15 to 20 minutes down to 6 to 7 minutes.

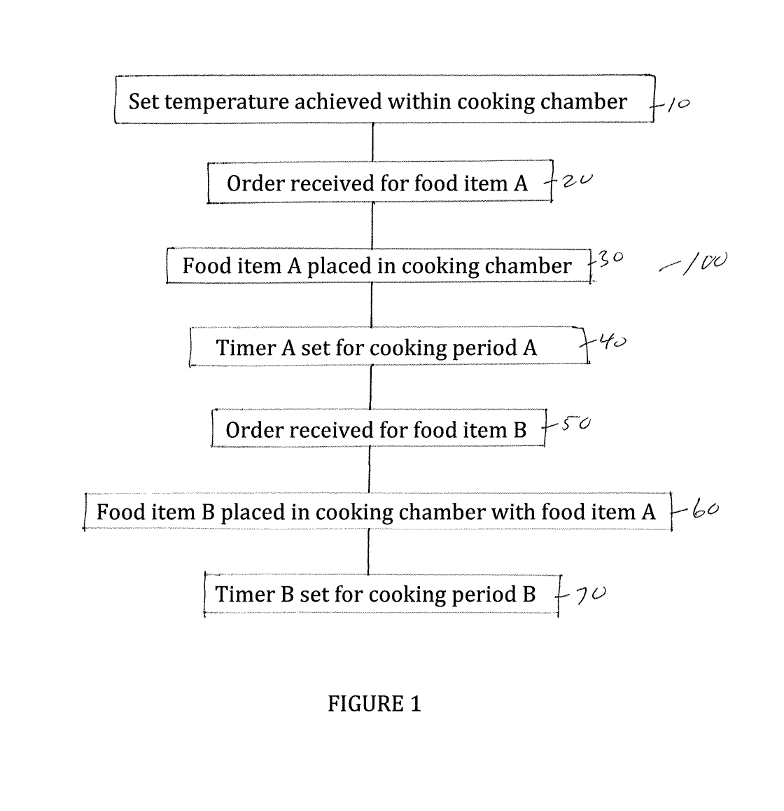

FIG. 1 illustrates one exemplary embodiment of a process enabled by the present invention, wherein a process 100 for cooking multiple food items at a single set temperature within the oven's cooking chamber is carried out in an exemplary restaurant setting.

Accordingly, once the set temperature is achieved within the cooking chamber of the oven 10, a first order is received for food item A in step 20. Next, food item A is placed in the cooking chamber of oven 30, and first timer, designated as timer “A” is set 40 for the required time period relating to the cooking time needed for food item A at the set temperature achieved in 10. Each set temperature will require establishing a new cooking period for each food type in a directly proportional manner, i.e., the higher the set temperature, the lower the cooking period.

This process is repeated in steps 50-70 for newly ordered food item B. Food item B may, or may not be, the same type of food as food item A. If food items A and B are the same type, e.g., pizza, then the cooking periods will be the same. The difference is that in step 70, food B's cooking period, initiated by the setting of timer B, is started after the initiation of food A's cooking period, initiated by the setting of timer A in step 40. If, on the other hand, food items A and B are of different food types, e.g., A is pizza and B is a pan of cookies, each food item A and B will require different cooking periods as well as different starting times, with timer A being set before timer B.

Ultimately, timers A and B will annunciate, using light and/or sound to announce the ending of cooking period A and cooking period B. Food items A and B are then properly cooked and may be removed from the cooking chamber. As noted above, even though food item A is placed in the cooking chamber first, food item B may comprise a shorter cooking period and, as a result, the end of cooking period B may coincide with the end of cooking period A or may end before the end of cooking period A.

This process may be repeated again for additional food items, up to as many as four, or more in various embodiments, of different food items may be cooked within the present invention, each food item having potentially a different starting time and/or different cooking periods associated therewith. The limiting factors are cooking space within the oven's cooking chamber and number of timers associated therewith. The skilled artisan will recognize that the present invention may comprise at least two timers, but may include more than two, with four timers being the most preferred embodiment.

When the oven door is opened to pre-heated cooking chamber, the temperature within the cooking chamber does not change for several reasons. First, as described in Lara, the fan remains activated in order to maintain the temperature within the cooking chamber. In addition, the cooking chamber comprises a slight negative pressure therein which minimizes the escape of pre-heated air and heat loss.

Operationally, consider an exemplary oven having at least four cooking positions within a cooking chamber and at least four independently operable timers associated, each associated with a particular cooking position, wherein each cooking position is further associated with a food item that may be placed thereon. The oven chamber's set temperature is 460 degrees Fahrenheit and is, at the beginning of the day, set and achieved. The oven is now ready to receive multiple food orders.

In various embodiments, the process of the present invention may comprise the oven chamber having a set temperature, a plurality of food item placement positions, e.g., a rack or portion of a rack, and a plurality of timers, each of the plurality of timers being associated with one of the plurality of the food item placement positions.

The present invention should not be considered limited to the particular examples described above, but rather should be understood to cover all aspects of the invention. Various modifications, equivalent processes, as well as numerous structures to which the present invention may be applicable will be readily apparent to those of skill in the art to which the present invention is directed upon review of the present specification.

What is claimed is:

1. A process for cooking multiple food items at a single set temperature within the oven's cooking chamber, comprising:
providing an oven with a cooking chamber having more than one cooking position and a combination of infrared convection, convection and rotary air impingement cooking technologies;
ensuring the cooking chamber temperature is fixed at the set temperature;
placing a first food item within the cooking chamber in a first cooking position, the first food item having an established cooking period at the set temperature;
setting a first timer associated with the first food item for the established cooking period for the first food item;
placing a second food item within the cooking chamber in a second cooking position, the second food item having an established cooking period at the set temperature;
setting a second timer associated with the second food item for the established cooking period for the second food item;
placing a third food item within the cooking chamber in a third cooking position, the third food item having an established cooking period at the set temperature;
setting a third timer associated with the third foot item for the established cooking period for the third foot item; and
removing each of the first, second and third food items from the cooking chamber in response to annunciation of completion of the established cooking period by the associated timer for each of the food items.

2. The process of claim 1, wherein each of the first, second and third food items comprise the same food type and the same established cooking period.

3. The process of claim 2, wherein each of the established cooking periods for the first, second and third food items comprise a different starting time.

4. The process of claim 3, wherein each of the established cooking periods for the first, second and third food items comprise a different end time.

5. The process of claim 1, wherein each of the first, second and third food items comprise different food types and different established cooking periods.

6. The process of claim 5, wherein each of the different established cooking periods for the first, second and third food items comprise a different starting time.

7. A process for cooking a plurality of food items at a single set temperature within the oven's cooking chamber, comprising:
providing an oven with a cooking chamber having a plurality of cooking positions and further comprising a plurality of timers, each timer associated with one of the plurality of cooking positions, and a combination of infrared convection, convection and rotary air impingement cooking technologies;
ensuring the cooking chamber temperature is fixed at the set temperature;
placing each of the plurality of food items to be cooked in one of the plurality of cooking positions within the cooking chamber;
setting each of the plurality of timers associated with one of the plurality of cooking positions with food items thereon to an established cooking period for the set temperature within the cooking chamber; and
successively removing each of the plurality of the food items from the cooking chamber in response to annunciation of completion of the established cooking period by the associated timer for each of the plurality of food items.

8. The process of claim 7, wherein each of the plurality of food items comprise the same food type and the same established cooking period.

9. The process of claim 8, wherein each of the established cooking periods for the plurality of food items comprise a different starting time.

10. The process of claim 9, wherein each of the established cooking periods for the plurality of food items comprise a different end time.

11. The process of claim 7, wherein each of the plurality of food items comprise different food types and different established cooking periods.

12. The process of claim 11, wherein each of the different established cooking periods for the plurality of food items comprise a different starting time.
